(19) United States
(12) Patent Application Publication
(10) Pub. No.: US 2011/0268956 A1
(43) Pub. Date: Nov. 3, 2011

(54) METHOD FOR OBTAINING CERAMIC COATINGS AND CERAMIC COATINGS OBTAINED

(75) Inventors: Inaki Fagoaga Altuna, Guipuzcoa (ES); Maria Parco Camacaro, Guipuzcoa (ES); Georgiy Barikyn, Guipuzcoa (ES); Carlos Vaquero Gonzalez, Guipuzcoa (ES)

(73) Assignee: FUNDACION INASMET, Guipuzcoa (ES)

(21) Appl. No.: 12/300,491

(22) PCT Filed: May 12, 2006
(86) PCT No.: PCT/ES06/00249

§ 371 Date: Feb. 13, 2009

(51) Int. Cl. C23C 4/10; B32B 3/26; C01G 25/02; C01F 7/02; C01F 11/02; C01G 37/02; C01F 17/00; C01B 33/12; C01F 5/00; C01G 45/02; B32B 9/00; C01G 23/047

(52) U.S. Cl. 428/304.4; 427/448; 428/332; 423/608; 423/625; 423/610; 423/607; 423/263; 423/335; 423/635; 423/605

(57) ABSTRACT

The invention relates to a process for obtaining ceramic coatings and ceramic coatings obtained. This process allows obtaining coatings of ceramic oxides, such as ZrO₂, Al₂O₃, TiO₂, Cr₂O₃, Y₂O₃, SiO₂, CaO, MgO, CeO₂, Sc₂O₃, MnO, and/or complex mixtures thereof, by means of a high frequency pulse detonation technique in which the relative movement between the combustion stream and the substrate or piece to be coated takes place at a speed that produces an overlap between the successive coating areas exceeding 60% of the surface of a coating area. The allows producing ceramic coatings with a thickness greater than 30 microns in a single pass.

### OBJECT OF THE INVENTION

The present invention is comprised within the field of processes for obtaining ceramic coatings and more specifically, processes using high frequency pulse detonation thermal spray techniques.

The process of the invention allows generating very dense ceramic layers with moderate heating of the substrate determined by the low consumption of process gases.

The process of the invention is especially suitable for obtaining ceramic coatings such as ZrO₂, Al₂O₃, TiO₂, Cr₂O₃, Y₂O₃, SiO₂, CaO, MgO, CeO₂, Sc₂O₃, MnO, and/or mixtures thereof.

### BACKGROUND OF THE INVENTION

Techniques for obtaining coatings by thermal spray are based on generating a combustion flame or stream to process a coating material which, by means of equipment generically known as guns, is directed or sprayed towards the substrate or piece to be coated, producing coating points or areas in one part of the surface of the substrate to be coated. The coating material is fed into the gun generally in wire or powder form. The coating is generated as a result of the solidification of the coating material sprayed with certain speed and temperature conditions on the surface of the substrate or piece to be coated. The complete coating of the surface of the substrate or piece is achieved by means of the relative movement of the gun (combustion stream) and the substrate or piece to be coated, defining a spray path traveling the entire surface to be coated, hereinafter referred to as a spray pass.

The surface is generally coated in its entirety in each spray pass with a few microns of the coating material (generally fewer than 30 microns per pass) necessary for each application. The functional or final coatings are thus generated by multiple and successive overlays of said spray passes, to achieve the required thicknesses for each application (generally several tenths of a millimeter thick).

Thermal spray processes can be classified as continuous and discontinuous according to the temporal nature of the flame.

Electric arc, plasma and detonation techniques are included among the continuous processes, according to the nature of the energy source producing the flame.

Under ideal operating conditions, in a certain section of the flame (combustion stream), the gases generated in continuous spray processes have a temperature and spatial velocity (two-dimensional) distribution stationary in time. The highest energy density is in the center of the flame (higher speed, temperature, density, . . . ), gradually decreasing until the edge thereof. The resulting energy distribution is reflected in the properties of the processed particles, a gradual decrease likewise being observed in the speed and the temperature thereof from the center towards the edge of the flame (combustion stream). Accordingly, significant differences can be observed in the degree of melting and the speed of the particles reaching the surface of the substrate, resulting in different mechanisms of layer solidification and formation. As a result, the profile of the spray path has a distribution, with a thicker and denser central area progressively decreasing towards the edges.

In most applications, the relative gun-substrate movement in a single direction is not enough to coat the entire surface of the substrate, therefore it is necessary to describe at least two-dimensional trajectories comprising movement in a first direction, and at least one movement comprising movement in a second direction, which can be perpendicular to the first direction, and a new movement according to a direction substantially parallel to the first movement direction, at least one second spray path being obtained. The two movements according to parallel directions are made with a certain degree of overlap (lateral overlap) between the first path and the at least one second spray path, and so on and so forth between each spray path and a contiguous subsequent path.

Since the coating is formed through the lateral overlap between adjacent sections of these spray paths, there are accordingly higher density areas alternated with other areas where the degree of compaction and the cohesion of the coating, and therefore its density, is lower.

Discontinuous processes are pulse detonation techniques generating cyclic and transient explosions lasting a few milliseconds, producing supersonic and discontinuous flows of the combustion gases (combustion stream). Low and high frequency pulse thermal spray technologies are included on the market among such spray technologies. Among the former, the best known is the D-Gun (U.S. Pat. No. 3,004,822), the typical detonation frequency of which is from 1 to 10 Hz. High frequency pulse detonation (known by its acronym HFPD) has recently been introduced on the market (WO97/23299, WO97/23301, WO97/23302, WO97/23303, WO98/29191, WO99/12653, WO99/37406 and WO01/30506) and can operate at frequencies exceeding 100 Hz.

The high frequency detonation spray techniques use the flows of the gases produced during the cyclic explosions or detonations to accelerate and spray the coating material and differ from low frequency detonation techniques, known as D-Gun (U.S. Pat. No. 3,004,822 A), in the absence of mechanical valves or other mobile elements, the pulse performance being achieved from the actual dynamics of the fluids, from a continuous supply of gases. Electronically controllable high frequency explosions are thus obtained which can exceed 100 Hz in comparison with the frequencies of a D-Gun process working between 1 and 10 Hz. Accordingly, the possibility of controlling the frequency of the explosions in the range of 1 to 100 Hz allows achieving higher production with these techniques.

Additionally, these techniques allow generating high or low temperature explosions using combustion gases such as methane and natural gas, or propane, propylene, ethylene or acetylene type gases, using mixtures rich in oxygen and controlling the amount of gases involved in each explosion. This lends great versatility to the high frequency pulse detonation (HFPD) spray process, allowing the deposition of materials of all types, from metal alloys to ceramics, achieving good adhesion and compaction.

In contrast to continuous processes, the transience inherent in discontinuous spray processes introduces a temporal element in the flame temperature and speed distribution in a certain section thereof, such that the spray paths have a two-dimensional profile varying throughout the forward movement direction of the gun, as a result of the overlap produced by the material deposited in each shot. Specifically, a coating area located in a part of the surface to be coated which is opposite the combustion stream is produced in each shot or explosion of a discontinuous process, such that the relative movement of the gun (combustion stream) and the substrate or piece to be coated produces successive coating areas in the surface of the substrate or piece, the coating areas being moved from one another a distance corresponding to the movement between the gun and the substrate or piece between two successive detonations, such that the successive coating areas partially overlap one another (transverse overlap) to form a first spray path.

In order to coat the entire surface of the substrate, it is necessary to describe three-dimensional trajectories comprising a movement in a first direction (it generates the mentioned first spray path), at least one movement comprising a movement in a second direction, which can be perpendicular to the first direction, and a new movement according to a direction substantially parallel to the first movement direction, at least one second spray path being obtained. The two movements according to parallel directions are made with a certain degree of overlap (lateral overlap) between the first path and the at least one second spray path and so on and so forth between each spray path and a contiguous subsequent path until completing one pass by means of which the entire surface of the substrate or piece to be coated has been covered. The coating is completed with a receding movement between the gun and the substrate and the repetition of the movements according to the first and second direction, obtaining spray paths overlaid on the spray paths of the previous pass. Different passes are made until obtaining suitable thickness for the coating to be obtained.

Among the wide variety of thermal spray techniques by continuous processes currently available, plasma spray processes are used par excellence at the industrial level for depositing refractory ceramic materials. Only the high energy density achieved with these processes makes it possible to process refractory materials with high yields. The processes commonly used are vacuum plasma spray (VPS), low pressure plasma spray (LPPS) and atmospheric plasma spray (APS). Although controlled atmosphere plasma spray (VPS and LPPS) involves certain benefits in relation to the minimum thicknesses achieved and the density of the coating, these processes have the drawback of their high price and low production, as well as the dimensional limitations for the pieces to be treated derived from the need to use vacuum chambers. For this reason, atmospheric plasma spray (APS) has a comparatively larger field of industrial application. However, the gas flow rates generated by plasma systems are generally moderate (100-200 m/s), producing coatings with insufficient densities and/or adherences for many industrial applications. Some strategies for increasing the density of these coatings have been successfully explored, such as the subsequent sintering by means of a technique known as HIP (hot isostatic pressing) and melting the surface of the coating by means of a localized plasma treatment (U.S. Pat. No. 6,180,260) or with laser radiation, among others. However, all these alternatives imply prolonging the production chain and therefore increasing process costs.

Furthermore, the high melting point and low conductivity of refractory ceramics limit the processing of these materials by means of conventional continuous combustion techniques. Traditionally, only low speed combustion techniques operated with acetylene as the combustible gas have any sort of industrial application.

However, there is growing interest in the use of techniques of high velocity continuous combustion such as high velocity oxy-fuel (HVOF) and pulse detonation (D-Gun) to improve the quality, compaction and hardness of the ceramic coating, though there are very few successful references of this approach. The limitation of these techniques is focused on the short residence time of the particles of the coating material in the flame (combustion stream), and accordingly, the deficient heating thereof. The acceleration of particles of the unmelted coating material in the flame results in a grit blasting effect on the previously deposited material, preventing an efficient formation of the coating layer.

By means of the high frequency pulse detonation spray (HFPD) technique, it is possible to achieve the desired heating of the ceramic particles by means of the combination of highly energetic gaseous mixtures and process parameters resulting in long enough residence times. Cyclic explosions are used in this process to heat and accelerate the particles of the coating powder, distributed with the explosive mixture in a cloud inside the barrel of the gun. A high speed of the particles of the coating material during the spray (resulting from the explosions) can thus be uniquely combined with a degree of melting thereof suitable for constructing the coating; resulting in high density, compactability and adherence coatings.

An important advantage of the high frequency pulse detonation (HFPD) technique is determined by the low energy load transmitted to the substrate during the deposition process. In conventional plasma spray processes, the difference between the coefficient of thermal expansion of the substrate and the coating may cause considerable residual stress in the coating and in the interface with the substrate, limiting the thickness of the layer which can be deposited in each pass of the gun over the substrate without delamination thereof occurring. Additionally, the relative minimum speed at which the gun can move with regard to the piece or substrate to be coated without causing it to overheat is conditioned by the geometry thereof. In the special case of ceramic material deposition, this problem is usually even more critical. Unlike continuous processes, the heat generated by pulse detonation processes is transmitted to the substrate in discrete amounts, resulting in a lower total transfer of energy to the coated piece. This is reflected positively in the level of residual stress of the coating/substrate system, making it possible to deposit in each pass thicknesses exceeding those achieved with conventional plasma processes. This translates into being able to achieve with the pulse detonation process the required thickness in the final functional coating with a lower number of passes.

Interest in ceramic-based coatings has expanded today to many industrial sectors, there being few areas of activity in which examples of their application are not found. However, the industry demands higher technical performance along with lower implementation costs a dynamics of continued improvement of production and quality of the manufactured products. Interest in spray techniques such as the one described in this invention for the deposition of top-quality coatings with advantageous production characteristics in relation to alternative processes, is therefore comprehensible.

The most widely used ceramic coatings on an industrial level belong to the family of ceramic oxides such as ZrO₂, Al₂O₃, TiO₂, Cr₂O₃, Y₂O₃, SiO₂, CaO, MgO, CeO₂, Sc₂O₃, MnO, and/or mixtures thereof.

Alumina (Al₂O₃) is known for its refractory nature, corrosion resistance and hardness, being used for surface protection applications against wear in aggressive environments (corrosion, temperature, . . . ). Compositions including variable percentages of TiO₂, SiO₂, MgO, among other oxides, are also known for improving specific features or responding to the needs of more specific applications. Furthermore, one of the most relevant industrial applications of alumina is found in its dielectric nature, as electrical insulation, preferably high-purity Al₂O₃ being the preferred material. In all these applications the density, compactability and adherence of the coatings are essential for their functional performance. Thus, a layer of dense, compact and defect-free alumina is not only a barrier against the penetration of corrosive agents, but it has a higher hardness and internal cohesion, resulting in higher wear resistance. In addition, the electrical resistivity and the insulating capacity of an alumina coating are proportional to its density, using smaller layer thicknesses being possible the better the quality and compactness of the coating.

Another very relevant industrial ceramic is Cr₂O₃, in some cases with the presence of TiO₂ or SiO₂ in minor percentages, as a material extremely resistant to wear and with optimal friction or sliding qualities. All this together with considerable corrosion resistance makes it the material of choice in a vast amount of mechanical applications (pump shafts, bushings, mechanical seals, rods, . . . ). One of the best known applications is the formation of printing cylinders, in which a layer of Cr₂O₃ is treated by laser to generate a specific structure suitable for carrying and distributing printing inks. One of the essential requirements is the quality of the layer of Cr₂O₃, in terms of hardness, compactability and adherence, in order to be able to handle the laser treatment thereof. Here, a specific problem refers to the presence of metal particles in the coating, a common phenomenon in plasma spray as a result of the melting of particles of the electrodes, which may lead to the coating as a whole being destroyed during the laser treatment. Therefore, the interest in obtaining extremely wear resistant coatings is complemented with the “clean” nature of a combustion process such as the one included in the invention, in which there are no electrodes and therefore no metal contamination caused by such electrodes.

The high ionic conductivity of oxygen in zirconia stabilized with yttria (ZrO₂):(Y₂O₃) at high temperatures has been known for many years and has made this material one of the most widely studied anionic conductors, resulting from its interest in the manufacture of electrolytes in solid oxide fuel cells (SOFC). The electrolyte is an essential component in the operation of unit cells, and therefore in the performance and efficiency of the fuel cell as a whole. In the past few years, the development of this technological sector has been driven by the need to reduce production costs and increase durability of the cells. The main strategy for achieving a cost reduction has been based on the implementation of low-cost, novel materials and the simplification of processing techniques. In response to the need to improve long-term performance, the main tendency has been to reduce the operating temperature of the system. To achieve this objective without sacrificing the power produced by the system, it is necessary, among other things, for the electrolyte to have a high ionic conductivity and for its thickness to be as small as possible to reduce electrical losses. Additionally, the manufacturing strategy thereof must be compatible with the rest of the components of the cell (anode, cathode, support, conductors, seal, geometries . . . ). In practice, thicknesses between 10 and 50 μm are required, which involves a significant technological difficulty considering that the electrolyte must maintain its impermeability to the hydrogen/fuel gas flow towards the cathode.

In this context, thermal spray techniques are, due to their simplicity, one of the options having the greatest potential. The energy conditions obtained with conventional plasma spray processes make the deposition of high density ceramic layers possible without the need for thermal treatments after deposition. Processes of this type are described in patents US2004018409, WO03075383 and EP0481679. However, depending on the economic expectations provided for the insertion of SOFC-type fuel cell technology, the cost reduction achieved with these spray techniques continues to be insufficient. In addition, the high energy density required to achieve melting the ceramic material involves a considerable heat transfer to the substrate to be coated during the deposition process, which limits the geometry of the substrate susceptible to being coated. Other developments are based on the use of more sophisticated techniques such as physical vapor deposition (PVD) (U.S. Pat. No. 6,007,683), the application of which is limited due to the high cost of these processes.

In any case, no process is known today which allows obtaining thin layers of zirconia with high production rates, high density and reduced price, and which in turn is compatible with the porous metal substrates commonly used as a support for the manufacture of unit cells. The process object of the invention exceeds the limitations of the previously described deposition processes by using a simple, low cost pulse detonation process, with which the thickness and density requirements for the manufacture of the electrolyte are achieved in a single pass of the gun over the substrate, without the need for any subsequent thermal treatment. Additionally, the low volume of gases involved in the pulse detonation process makes the processing of substrates sensitive to deformation or chemical decomposition as a result of the thermal load transferred during the deposition process with conventional thermal spray techniques possible.

In addition, the partially or completely stabilized zirconia coatings are normally used as thermal insulation or a thermal barrier for the protection of metallic components in high temperature environments, such as in different components of a gas turbine for example. In practice, these coatings are deposited by means of thermal spray techniques, especially by means of LPPS and APS, and by means of gas phase deposition techniques, especially by electron beam physical vapor deposition (EB-PVD). Besides the economic factor, the applicability of each of these processes is conditioned by the intrinsic characteristics of the resulting coating, such as porosity, morphology of the grains/lamellas and their internal cohesion. In the case of the applications covered plasma spray techniques, there is a growing interest in improving the wear resistance of the coatings under extreme temperature conditions, usually limited by their low compactability.

To this effect, zirconia coatings achieved with the process object of the invention have hardness and density features that are far superior to those achieved with conventional thermal plasma spray processes in atmospheric conditions. The high compactability of the zirconia coatings deposited by means of the described process involve high anti-erosive features which could contribute to generating new applications for these materials and consolidate the use of thermal spray techniques.

Besides its application in solid electrolytes and thermal barriers, zirconia has a wide range of applications as a result of its properties. Applications in which the coatings generated with the process of the invention could be used include those connected with: a) protecting molds or pieces in contact with molten metals, b) manufacturing piezoelectric components, pyroelectric components, capacitors c) structural ceramics, d) ceramic heating elements, and e) oxygen sensors.

### DESCRIPTION OF THE INVENTION

The process object of the invention allows obtaining high density ceramic coatings, using to that end high frequency pulse detonation HFPD techniques.

An object of the invention is a process comprising:

introducing at least one fuel and one combustion agent in a combustion chamber, provided with at least one outlet,

generating in the mentioned combustion chamber cyclic explosions of a frequency exceeding 10 Hz, producing a combustion of said at least one fuel and combustion agent exiting through the mentioned at least one outlet in the form of a combustion stream,

adding to the mentioned combustion stream a coating material, such that said coating material is mixed with the combustion stream,

projecting the combustion stream on a substrate or piece to be coated with the coating material producing, in each explosion, a coating area in one part of the surface of the substrate or piece to be coated, opposite the combustion stream,

producing a relative movement of the combustion stream and the substrate or piece to be coated according to a first movement direction, such that successive coating areas are produced in the surface of the substrate or piece to be coated, and the coating areas being moved from one another a distance corresponding to the movement between the combustion stream and the substrate or piece between two successive detonations, defining in the successive coating areas a first spray path on the substrate or piece to be coated,

the relative movement of the combustion stream and the substrate or piece taking place at a speed producing an overlap between the successive coating areas exceeding 60% of the surface of a coating area.

The process of the invention can comprise producing at least one relative movement of the combustion stream and the substrate or piece comprising

a movement according to a second movement direction, and then

a movement according to a direction substantially parallel to the first movement direction,

producing at least one second spray path overlapped with the first spray path, the overlap between the first path and the second path being less than 10% of the surface of the first path.

The second movement direction can be substantially perpendicular to the first movement direction.

The first path and the at least one second path can form a coating with a thickness exceeding 30 microns. This coating can be obtained in a single pass, i.e., it is not necessary to perform new passes overlaid on the first or the second path obtained. The number of interfaces, and therefore the density of volumetric defects included in the final coating, is thus reduced.

Also object of the invention is a ceramic coating obtainable according to the process object of the invention.

As stated, high frequency pulse detonation spray processes are characterized by a deposition pattern in the form of “discs” originated in each explosion. Based on the reasons that will be explained below, these discs have a profile which, depending on the materials provided and on their spray conditions, have larger or smaller thickness and density gradients from the central area to the ends. With the most refractory materials, as is the case of YSZ (ZrO₂):(Y₂O₃), it is possible to generate discs with an essentially cylindrical geometry, with very uniform thickness and density values on the entire surface and very abrupt transitions of said values at their edges.

In pulse detonation spray processes, the formation of the coating is the result of the transverse overlap of these “discs”, in addition to the lateral overlap between adjacent sections of the spray path (between the first and the second spray path).

For given supply parameters (gases and powder), the uniformity of the coating and the local heat transferred to the substrate depends on the degree of total overlap resulting from the kinematic spray conditions, which are what allow defining the position and the relative movement between the gun and the substrate.

For the deposition of ceramic powders by means of the high frequency pulse detonation HFPD technique, highly energetic detonation conditions are required which allow melting the ceramic powder. Specifically, high temperature combustion gases such as propane, propylene, ethylene or acetylene mixed with oxygen are used as a combustion agent to achieve a high temperature detonation and highly oxidizing environments.

The frequency of the explosions can be greater than 40 Hz to improve the production of the process and reduce the volume of gases used in each explosion. The ceramic powders are introduced in the barrel of the detonation gun at a point contiguous to the detonation chamber in order to force them to traverse the entire length of the barrel.

The refractory nature of ceramic powders has the result that only the particles with a suitable size that are in the central area of the flame can be melted. As a result, an abrupt transition is generated between the area of the flame carrying melted coating material and the area in which the heating of the particles is not enough to melt them, a deposition area thus being generated with each explosion in the surface of the substrate forming well defined and uniform discs surrounded by a very thin ring of material poorly adhered to the substrate. The thickness, size and microstructure of these discs depend on the physicochemical properties of the filler material and on the deposition parameters, therefore their microstructure can be used as a main tool for optimizing deposition parameters.

As a result of this abrupt transition, the mechanism of deposition of the particles processed in the center of the flame competes with the mechanism of grit blasting carried out by unmelted or semi-melted particles at the edge of the flame. At relatively high transverse speeds of the gun (large relative movement between the combustion stream and the substrate), generating a small transverse overlap, the mechanism of grit blasting dominates over the mechanism of deposition, eliminating the material previously deposited with the previous explosion and preventing the formation of the coating, such that the ceramic layer can only be formed if the relative transverse speed of the gun is low enough to provide a high transverse overlap of the discs deposited with each explosion, a spray path thus being generated. The grit blasting effect is beneficial in this case to remove a portion of the particles deposited with the previous explosion which, due to their low energy condition, attain insufficient adherence to the substrate; thus contributing to eliminating volumetric defects or “edge defects” (pores, cracks, among others) between discs.

The limit transverse speed above which the grit blasting process dominates and coating is not generated can be related with the morphology of the discs deposited in each explosion. To overlap small discs, typically produced with zirconia completely stabilized with yttria, relatively low process speeds are required. In contrast, the discs produced with less refractory ceramics such as zirconia partially stabilized with yttria or Al₂O₃ are larger and thicker, which allows using a wider range of speeds to achieve their overlap and, therefore, the generation of the coating.

A higher degree of compaction in the coating can be obtained for each ceramic material under the limit transverse speed as said speed is reduced. The higher degree of transverse overlap of the discs contributes based on the foregoing to the elimination of edge defects between discs, thus reducing the density of total defects inside the spray path. However, the surface of the resulting spray path is an area with a high density of defects, since the material poorly adhered on the discs is not efficiently eliminated by the grit blasting effect. As a result, a high lateral overlap of the spray paths or the deposition of several passes must be prevented in order to reduce the total density of defects in the coating. An extreme case is observed in the deposition of coatings with highly refractory materials such as YSZ, in which the high density of surface defects of the spray path prevents the adherence between the layers generated in each pass, and even the adherence between them when the lateral overlap is very high (>50%). In these cases, the separation between the passes can be observed by means of a simple inspection of the cross-section of the coating by optical microscopy.

Therefore, the high frequency pulse detonation spray process of the invention is based on obtaining a high transverse overlap (greater than 60%), a minimum lateral overlap (less than 10%), which allows achieving the functional final coating (with the necessary thickness) in a single pass. Specifically, thicknesses exceeding 30 microns can be obtained in a single pass.

The examples describe coatings obtained with three industrially relevant materials such as zirconia partially stabilized with yttria ZrO₂:Y₂O₃, alumina Al₂O₃ and chromium oxide Cr₂O₃, and processed at low gun-substrate transverse speeds, providing high transverse overlap indices.

In addition, the morphology of the particles, and therefore the route for manufacturing the powder, also play a determining role in the morphology of the discs deposited in each explosion. In particular, angular particles manufactured by melting and grinding result in coatings with a higher degree of compaction, as a result of the fact that only the completely melted particles can form the layer. In contrast, spherical particles manufactured by agglomeration and subsequent sintering are generally easier to deposit since only a melting/plasticization of the surface thereof is required to achieve their adherence to the substrate. Upon impacting on the surface of the substrate, such particles are fractioned, leaving small conglomerates of unmelted particles. Accordingly, the agglomerated powders can be processed with a broader range of parameters, generally achieving higher deposition efficiencies, and nevertheless resulting in coatings having a higher porosity.

### DESCRIPTION OF THE DRAWINGS

To complement the description being made and for the purpose of aiding to better understand the features of the invention, a set of drawings is attached as an integral part of said description in which the following is shown with an illustrative and non-limiting character:

FIG. 1 shows a general scheme of a spray path generated on a substrate in a continuous thermal spray process.

FIG. 2a shows a schematic depiction of the mechanism for the formation of a complete coating by means of a continuous thermal combustion process.

FIG. 2b shows a schematic depiction of the mechanism for the formation of a complete coating by means of a discontinuous thermal combustion process.

FIG. 3 shows the typical morphology of the coating areas formed by the deformation of the particles of the coating material in thermal spray processes depending on the temperature and speed thereof.

FIG. 4 shows a general view of coating areas, forming discs, of YSZ ((ZrO₂):(Y₂O₃)) obtained in static conditions with a high frequency pulse detonation spray process.

FIG. 5 shows a schematic depiction of the effect of the transverse speed of the high frequency pulse detonation spray gun on the mechanism for the formation of the layer.

FIG. 6 shows the microstructure of a ZrO₂ coating partially stabilized with Y₂O₃ (7% by weight) obtained according to the process object of the invention.

FIG. 7 shows the microstructure of a ZrO₂ coating completely stabilized with Y₂O₃ (8% mol) obtained according to the process object of the invention.

FIG. 8 shows the structure of an Al₂O₃ coating obtained according to the process object of the invention.

FIG. 9 shows the structure of a Cr₂O₃ coating obtained according to the process object of the invention.

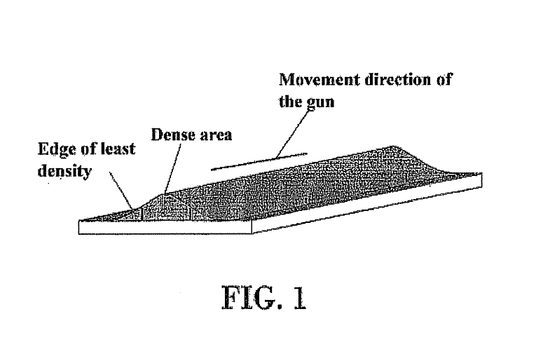

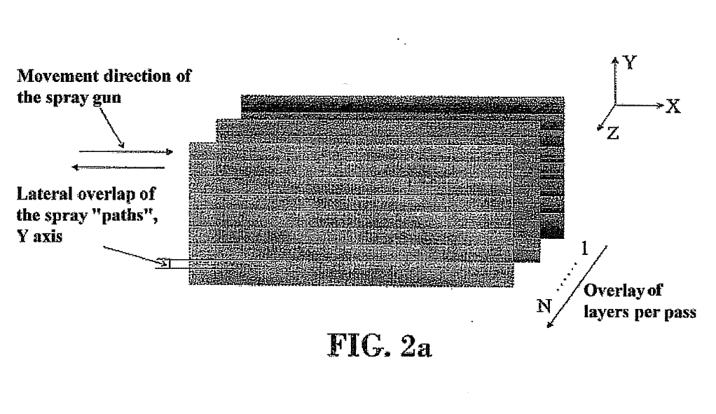

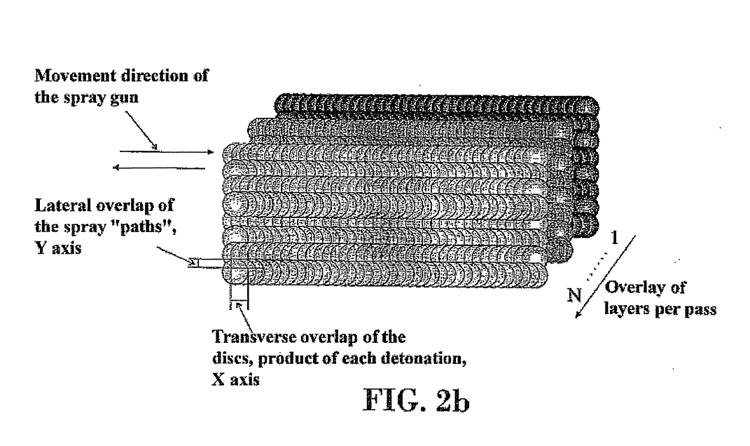

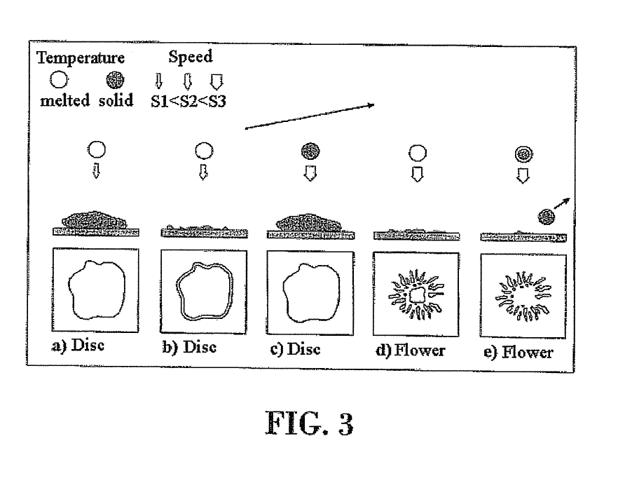

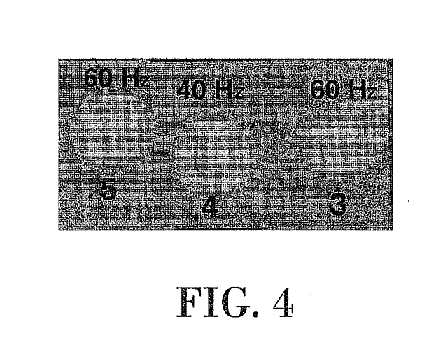

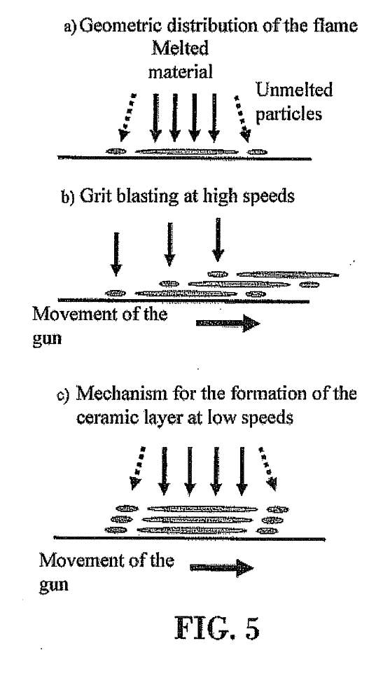

### PREFERRED EMBODIMENT OF THE INVENTION

Four examples of ceramic coatings obtained according to the process of the invention are described below.

### Example 1

The following was used as a coating material: angular particles (−22.5+5 μm) of ZrO₂ partially stabilized with 7% by weight of Y₂O₃ (Amperit 825.0). The spray was performed by means of high frequency pulse detonation techniques with the following parameters:
Propylene flow rate (slpm): 50
Oxygen flow rate (slpm): 180
Frequency (Hz): 60
Nitrogen carrier gas (slpm): 50
Feed: 18 g/min, a coating of approximately 40 μm thick being obtained in a single pass at a relative speed of 5 cm/s.
Spray distance (mm): 40

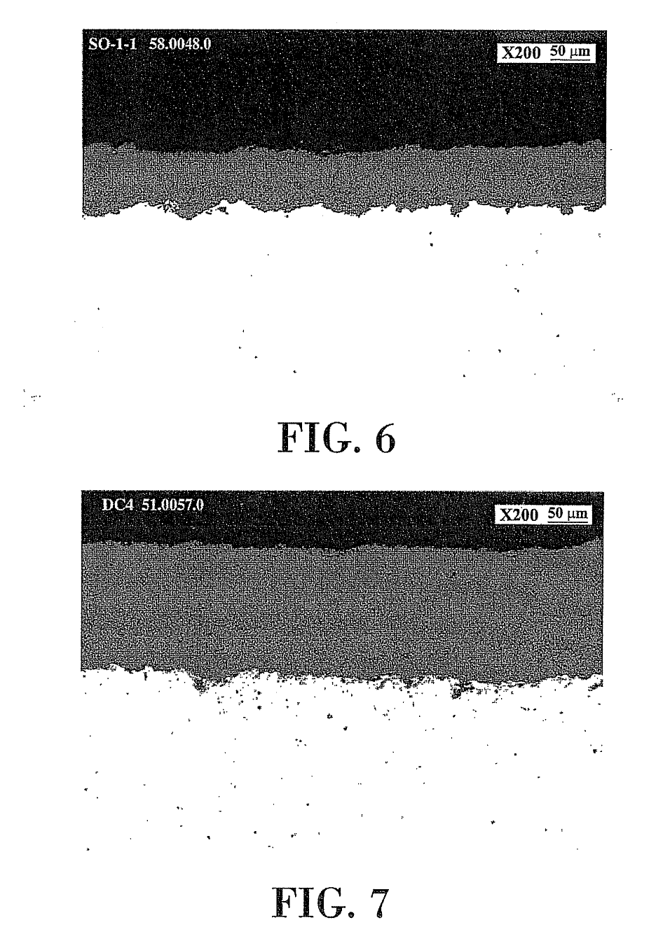

A coating with a hardness of 934 HV_{0.3} and a porosity less than 1% was obtained with these parameters. The microstructure of this coating can be observed in FIG. 6.

### Example 2

The following was used as a coating material: angular particles (−25 μm) of ZrO₂ completely stabilized with 8% mol Y₂O₃ (of Treibacher). The spray was performed by means of high frequency pulse detonation techniques with the following parameters:
Propylene flow rate (slpm): 50
Oxygen flow rate (slpm): 180
Frequency (Hz): 60
Nitrogen carrier gas (slpm): 50
Feed: 36 g/min, a coating of approximately 130 μm thick being obtained in a single pass at a relative speed of 5 cm/s.
Spray distance (mm): 40
Preheating of the substrate a 200 ° C.

A coating was obtained with these parameters with an average hardness of 944 HV_{0.3} and a porosity less than 1%, the microstructure of which is observed in FIG. 7.

### Example 3

The following was used as a coating material: angular particles (−22+5 μm) of Al₂O₃. The spray was performed by means of high frequency pulse detonation techniques with the following parameters:
Propylene flow rate (slpm): 50
Oxygen flow rate (slpm): 180
Frequency (Hz): 50
Nitrogen carrier gas (slpm): 40
Feed (g/min): 28
Spray distance (mm):
   a: 40 mm, a coating of approximately 300 μm thick being obtained in a single pass at a relative speed of 5 cm/s.
   b: 150 mm, a coating of approximately 200 μm thick being obtained in a single pass at a relative speed of 5 cm/s.

Coatings with porosity less than 2% and with an average hardness of: a) 1116 HV_{0.3}, the microstructure of which is observed in FIG. 8, and b) 996 HV_{0.3}, were obtained with these parameters. As can be observed, the deposition distance can significantly affect the degree of compaction of the layer, as a result of the loss of energy of the particles.

### Example 4

The following was used as a coating material: angular particles (−22+5 μm) of Cr₂O₃. The spray was performed by means of high frequency pulse detonation techniques with the following parameters:
Propylene flow rate (slpm): 50
Oxygen flow rate (slpm): 180
Frequency (Hz): 50
Nitrogen carrier gas (slpm): 40
Feed (g/min): 36
Spray distance: 40 mm, a coating of approximately 160 μm thick being obtained in a single pass at a relative speed of 5 cm/s.

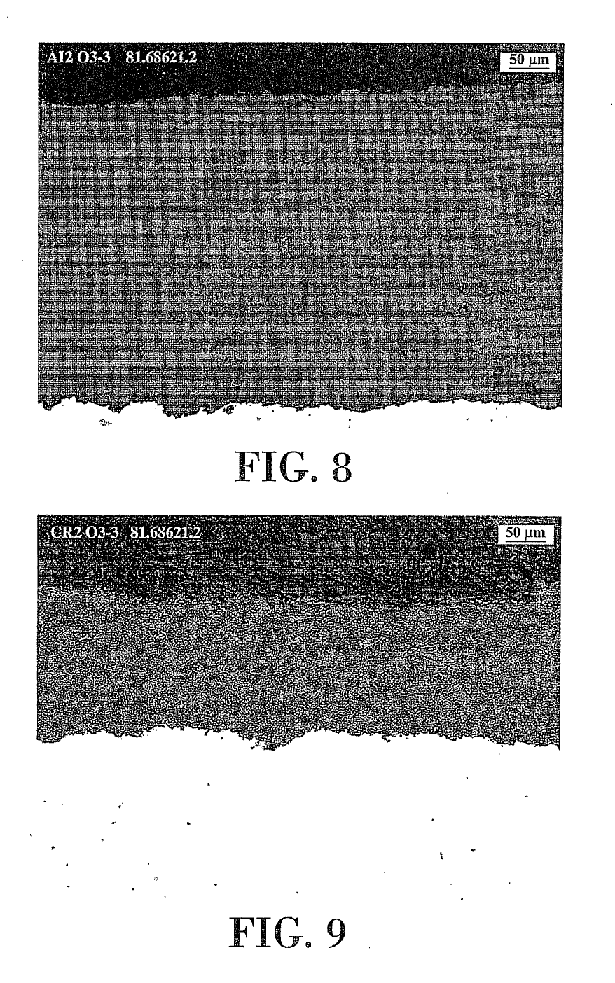

Coatings with an average hardness of 1346 HV_{0.3} and a porosity less than 1%, the microstructure of which is observed in FIG. 9, were obtained with these parameters.

1. Process for obtaining ceramic coatings, comprising:
introducing at least one fuel and one combustion agent in a combustion chamber provided with at least one outlet,
generating in the mentioned combustion chamber cyclic explosions of a frequency exceeding 10 Hz, producing a combustion of said at least one fuel and combustion agent exiting through the mentioned at least one outlet in the form of a combustion stream,
adding to the mentioned combustion stream a coating material, such that said coating material is mixed with the combustion stream,
projecting the combustion stream on a substrate or piece to be coated with the coating material producing, in each explosion, a coating area in one part of the surface of the substrate or piece to be coated, opposite the combustion stream,
producing a relative movement of the combustion stream and the substrate or piece to be coated according to a first movement direction, such that successive coating areas are produced in the surface of the substrate or piece to be coated, and the coating areas being moved from one another a distance corresponding to the movement between the combustion stream and the substrate or piece between two successive detonations, defining in the successive coating areas a first spray path on the substrate or piece to be coated,
characterized in that the relative movement of the combustion stream and the substrate or piece takes place at a speed producing an overlap between the successive coating areas exceeding 60% of the surface of a coating area.

2. Process for obtaining ceramic coatings according to claim 1, comprising producing at least one relative movement of the combustion stream and the substrate or piece comprising
a movement according to a second movement direction, and then,
a movement according to a direction substantially parallel to the first movement direction,
producing at least one second spray path overlapped with the first spray path, the overlap between the first path and the second path being less than 10% of the surface of the first path.

3. Process for obtaining ceramic coatings according to claim 2, wherein the second movement direction is substantially perpendicular to the first movement direction.

4. Process for obtaining ceramic coatings according to claim 2, wherein the first path and the at least one second path form a coating with a thickness exceeding 30 microns.

5. Process for obtaining ceramic coatings according to claim 4, wherein the mentioned coating is obtained in a single pass.

6. Ceramic coating obtainable according to a process according to any of claims 1-5.

7. Ceramic coating according to claim 6, characterized in that by using as a coating material a powder formed by angular ZrO₂ based particles, it has a hardness exceeding 900 HV_{0.3} and a porosity less than 1%.

8. Ceramic coating according to claim 6, characterized in that by using as a coating material a powder formed by angular Al₂O₃ based particles, it has a hardness exceeding 990 HV_{0.3} and a porosity less than 2%

9. Ceramic coating according to claim 6, characterized in that by using as a coating material a powder formed by angular Cr₂O₃ based particles, it has a hardness exceeding 1300 HV_{0.3} and a porosity less than 1%.
